(19) United States
(12) Patent Application Publication
(10) Pub. No.: US 2004/0267768 A1
(43) Pub. Date: Dec. 30, 2004

(54) Attribute based programming for data repositories

(75) Inventor: Andy Harjanto, Sammamish, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/607,914

(22) Filed: Jun. 27, 2003

(51) Int. Cl. G06F 17/00

(52) U.S. Cl. 707/100

(57) ABSTRACT

A directory interface utilizes a mapping of class properties to directory attributes to translate a request that does not employ the directory schema, syntax, and programming model to a request that does employ the directory schema, syntax, and programming model, and to translate returned results back to a format that does not employ the directory schema, syntax, and programming model. The mapping may be effectuated via metadata tagging of classes. A graphical mapping tool allows a user to easily complete desired mappings without the user being required to enumerate all of the relevant classes and/or attributes.

### FIELD OF THE INVENTION

This invention relates generally to data retrieval and, more particularly, relates to a system and method for attribute based programming for retrieving data from a repository.

### BACKGROUND

As computers and computer networks become more prevalent, especially in commercial and educational settings, the amount of information stored and retrieved digitally has greatly increased. A number of repositories are available for digital data storage, including directory services, databases, and so on. Exemplary repository technologies include Active Directory® directory service and SQL Server™ database, both produced by Microsoft® Corporation of Redmond, Wash., as well as other Lightweight Directory Access Protocol (LDAP)-compliant repositories and non-LDAP-compliant repositories.

Although an essentially unlimited number of usage scenarios for data repositories can be imagined, one important scenario for repository usage is in maintaining and accessing client information with respect to a business enterprise. For example, an online sales company typically accepts orders and associated client information online and stores such information in an LDAP-compliant directory or other directory. When data is to be written to, read from, or searched for in the directory, a responsible application or applications designed to understand the programming model, syntax, query language, schema, and protocol, if any, of the directory must be used.

Typically, the programming model, syntax, schema and so forth used for a particular directory are not intuitive to many users and developers. Moreover, they often vary from one repository to another. In a typical enterprise scenario, the business entity usually stores the information in various repositories. The complexity of directory access methodologies as well as the need to be familiar with and to use multiple such methodologies when multiple directory types are employed is daunting, causing a prohibitive level of complication for users of directories and developers of directory access software alike.

### BRIEF SUMMARY OF THE INVENTION

Embodiments of the invention provide a simplified mechanism for applications and administrators to interact with data repositories via a mapping of complex structures, protocols, etc. to a programming platform that is already well understood. In particular, in an embodiment of the invention, a directory interface is provided that accepts simplified commands that do not employ repository syntax and schema and translates the commands into reformatted commands that do utilize the appropriate syntax and schema. In this manner, and administrator or application may access a repository without being required to know or embody repository type-specific information. Moreover, the same class structure and syntax can then be used to access different repositories having varying schema and syntax.

In an embodiment of the invention, the ability to translate from repository non-specific commands to repository-specific commands is facilitated by a mapping of class data structures to repository data structures. In the schema repositories such as directory services there are typically repository classes (hereinafter sometimes referred to as schema classes), repository attributes, and repository syntax (hereinafter sometimes referred to as schema syntax). In the Object Oriented programming model, such as that of C++ and C#, there are typically object classes, object properties, and object syntax . With respect to the mapping of class data structures to repository data structures, an object class may be mapped to one or more schema classes within the repository schema, and particular class properties may then be mapped to particular schema attributes of the relevant schema class or classes. In a further embodiment of the invention, the mapping of object classes to schema classes, and object properties to schema attributes, is effectuated by supplementing the relevant object class definition via metadata.

The supplementation of the relevant class definition with metadata may be performed manually if desired. However, to aid the user in mapping object classes to schema classes, and properties to attributes, a mapping tool is provided in an embodiment of the invention. The mapping tool enumerates available object classes and schema classes, and the user can select an object class for mapping to a schema class. Once the object class/schema class mapping is selected, the user is presented with an additional user interface element for selecting a mapping of a class property to a schema attribute.

In an embodiment of the invention, the interface receives results returned from the repository pursuant to an access command. The interface translates the results to a repository non-specific form that does not embody the repository schema but that does embody the class structure understood by the calling application or user. In this manner, a user or application is able to access a directory or other repository without ever being required to understand the syntax, schema, programming model, etc. used by the repository. Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary device architecture in which embodiments of the present invention may be implemented;

FIG. 2A is a schematic diagram of an example system architecture usable in an embodiment of the invention to access a repository;

FIG. 2B is a schematic diagram of an alternative system architecture usable in an embodiment of the invention to access a repository;

FIG. 3 is a schematic diagram of an environment including a directory interface, according to an embodiment of the invention, for accessing a directory;

FIG. 4A is a schematic diagram illustrating a mapping of a class structure to directory schema attributes according to an embodiment of the invention;

FIG. 4B is a schematic diagram illustrating a mapping of an object class structure to directory schema attributes according to an alternative embodiment of the invention;

FIG. 5A is a schematic data structure representation of an object class definition usable to implement an embodiment of the invention;

FIG. 5B is a schematic data structure representation of a class definition usable to implement an embodiment of the invention wherein the class definition has been supplemented to include metadata defining a mapping of object class properties to directory schema attributes;

FIG. 6A is a simplified representation of a user interface of a mapping tool usable within an embodiment of the invention to initiate mapping of class properties to directory schema attributes;

FIG. 6B is a simplified representation of a user interface of a mapping tool usable within an embodiment of the invention to facilitate mapping of class properties to directory schema attributes;

FIG. 7 is a flow chart showing the steps of a process executed by a directory interface according to an embodiment of the invention to execute a request for directory access;

FIG. 8A is a screen shot of a user interface for mapping object classes to schema classes according to an alternative embodiment of the invention; and

FIG. 8B is a screen shot of a user interface for mapping object class properties to schema class attributes according to an alternative embodiment of the invention.

### DETAILED DESCRIPTION

Turning to the drawings, wherein like reference numerals refer to like elements, the invention is illustrated as being implemented in a suitable computing environment. Although not required, the invention will be described in the general context of computer-executable instructions, such as program modules, being executed by a computer such as a personal computer or otherwise. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

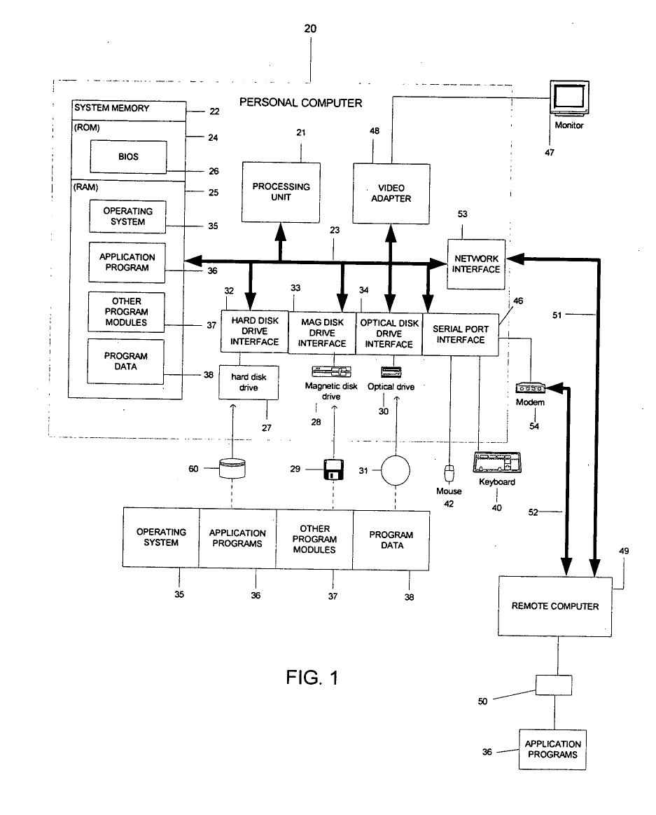

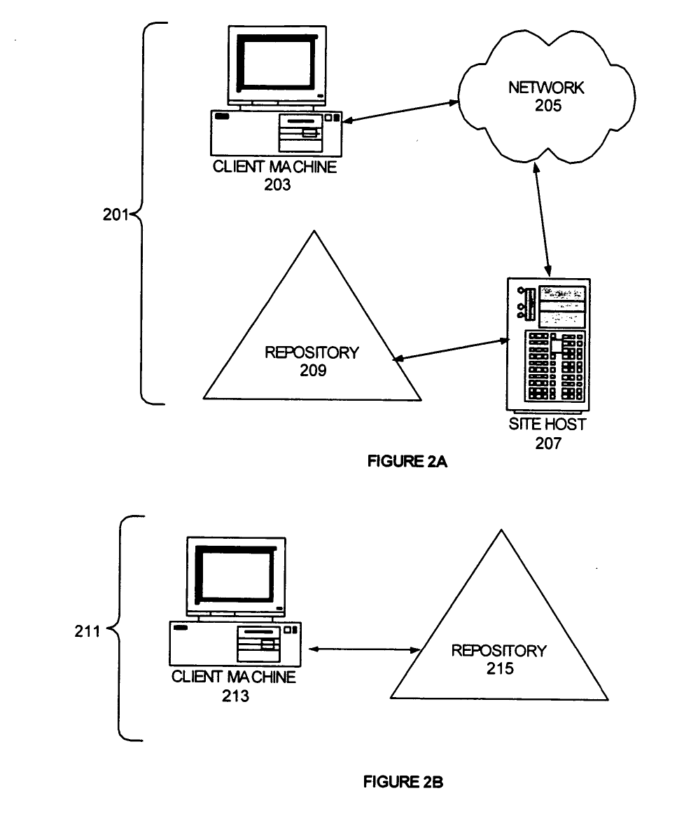

This description begins with a description of a general-purpose computing device that may be used in an exemplary system for implementing the invention, after which the invention will be described in greater detail with reference to FIG. 2 and subsequent Figures. Turning now to FIG. 1, a general purpose computing device is shown in the form of a conventional computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, computers typically include other peripheral output devices, not shown, such as speakers and printers.

The computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other means for establishing communications over the WAN 52. The modem 54, which may be internal or external, is connected to the system bus 23 via the serial port interface 46. Program modules depicted relative to the computer 20, or portions thereof, may be stored in the remote memory storage device if such is present. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

Turning to FIGS. 2A and 2B, example usage environments in which various embodiments of the invention may be implemented are shown. One or more of the devices shown in FIGS. 2A and 2B may comprise some or all of the aspects described above with respect to the computer 20 and/or remote computer 49 of FIG. 1, although any other type of computing device capable of performing operations described with respect to embodiments of the invention may be used to implement those embodiments. The environment 201 of FIG. 2A comprises a client machine 203, network 205, site host 207, and repository 209. In particular, the client machine 203, which may be any type of computing device, such as, for example, that described above with respect to FIG. 1, is connected to the site host 207, via the network 205. Typically the network 205 is or includes the Internet, although such is not required, and the site host 207 is a server that hosts one or more web sites. The repository 209 may be any data repository such as an Active Directory® or SQL Server™, both by Microsoft® Corporation of Redmond, Wash. Thus, although the Active Directory® is LDAP-compliant, such is merely exemplary and is not required.

The environment shown in FIG. 2A can be used to implement a number of types of functionality, however one typical use is within an online transaction wherein data is written to or read from the repository 209 as part of the transaction or to facilitate the transaction. An example of the latter is a situation wherein a user at the client machine 203 places an order on a commercial web site hosted by host 207. Typically one or more applications running at the host 207, and used for the ordering process, will use the repository 209 for storage of data such as inventory or customer data and will read and/or write such data from or to the repository 209 during the transaction. For example, customer purchase history may be stored and used to determine the amount of discounts to apply for a particular order, or customer name and/or address and/or credit card information may be stored and used to partially complete an order form to ease the customer's task.

In any case, the applications used on the host 207 to complete the ordering process must be able to communicate with the repository 209 to make the appropriate data exchanges that are required to facilitate the transaction. However, in order to communicate with the repository 209, such applications must be written with an understanding of the schema, syntax, and programming model of the repository. For example, in order to communicate with an Active Directory® directory service, the applications must understand LDAP commands, syntax, and query. If the repository 209 actually comprises multiple repositories of distinct types, the role of the applications used to read from, write to, and search the repositories 209 is even more complicated with respect to design and maintenance.

The term “schema” as used herein with respect to a repository denotes an organizational scheme applied to the data within a repository. For example, a schema may be hierarchical in nature comprising multiple identifiers in a lower level associated with each identifier in an immediately higher level. One such schema includes for example a “user” class or category at one level, with the properties of the user, such as “given name,” “surname,” “location,” and so on residing organizationally in a second level and being associated with the “user” class. In many such schema, the organizational scheme is triangular, with increasing levels of granularity at lower levels. In other schema, the organizational scheme may be flatter.

Typically the information in a database, as opposed to a directory, is organized in linked tables without an express hierarchical schema. However the relational model of such repositories may have an implicit hierarchical aspect in that, for example, a given table may contain 1 or more columns. In keeping with the foregoing example, a table called “User”, may have columns “given name,” “surname,” “location,” etc. in the relational data base. Furthermore, multiple tables are often linked. Prior to using such a repository in the implementation of certain embodiments of the invention, the schema implicit in the linked tables are preferably made explicit so that the mappings discussed herein can be more easily made by a developer or administrator. For example, this may be achieved by redefining the relationships defined by the tables and links as “views” that more explicitly reflect a hierarchical schema or organization.

The system configuration 211 shown in FIG. 2B is similar to that shown in FIG. 2A, except that the user is now situated at a machine 213 such as a workstation that directly accesses the repository 215. This type of configuration is usable when the user, such an administrator, requires access to the repository 215. Typically, the user of such a system will be more sophisticated than the user of the client machine 203 of the system 201 of FIG. 2A, and may access the repository in order to update data, etc. Without the benefit of the simplifications described herein, however, either the user or an application used by the user must be able to access the repository 215 using the appropriate schema, syntax, and programming model.

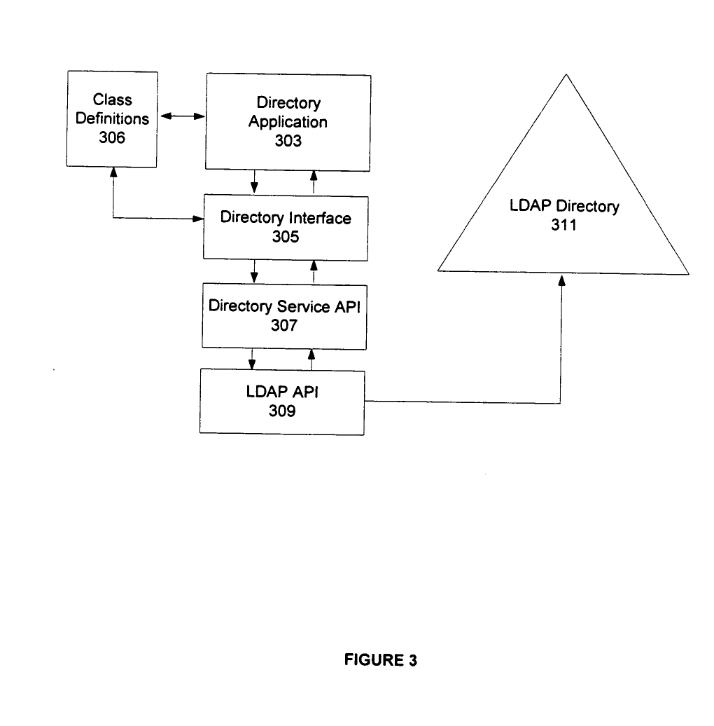

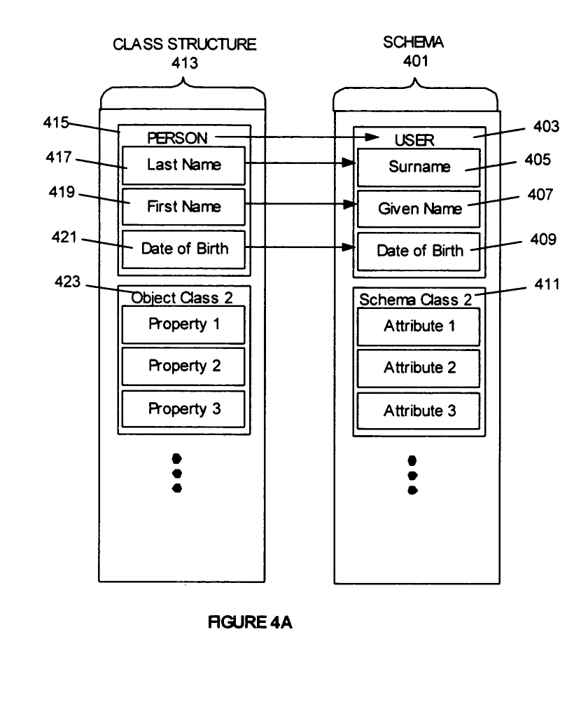

In an embodiment of the invention, a programming interface is provided for allowing access to a repository without requiring the user or application interacting with the repository to understand the schema, syntax, or programming model of the repository. The interface, its environment and its function will be explained in greater detail with respect to the example of FIG. 3, wherein the repository is an LDAP-compliant directory. In particular, a directory application 303 used by a user or other application to access the directory 311 directs high-level read, write, and search commands to a directory interface 305 via an interface thereto. These commands use the class definitions generally used by the application 303 rather than the syntax and schema of the repository 311 itself. In particular, the access commands used by the directory application 303 do not use the schema or syntax of the directory 311. Thus, the application 303 can use the same command structure and syntax for repositories of different types. Although the directory interface 305 is illustrated as a single entity, in an embodiment of the invention, the interface 305 comprises a plurality of separately callable entities, such as a read interface, search interface, and write interface.

Exemplary simplified directory read, write, and search commands are as follows:

```
    Write (Simplified)
Person person = new Person( );
person.FirstName = “John”;
person.LastName = “Smith”;
person.TelephoneNumber = “425 999-9999”;
person.Title = “Developer”;
DirectoryContext.Write( person );
    Read/Search (Simplified)
Person person = new Person( );
person.UserName = “jsmith”; // find person with user name equals to
jsmith;
Person c = DirectoryContext.FindOne(person);
Console.WriteLine( c.TelephoneNumber);
Console.WriteLine( c.Title)
```

To this end, the directory interface 305 translates a command that embodies the class structure used by the directory application 303 to a properly formatted command embodying the complex syntax and schema (schema classes and attributes) necessary to access the directory 311.

Exemplary reformatted directory read, write, and search commands are as follows:

```
Write (Reformatted)
LDAPMod Name, OClass, FName, LName, Title, Phone;
// Specify the distinguished name for the entry.
char *entry_dn = “cn=John Smith,CN=Users”;
Name.mod_op = LDAP_MOD_ADD;
Name.mod_type = “cn”;
Name.mod_values = “John Smith”;.
char *oc_values[ ] = { “user”, NULL };
OClass.mod_op = LDAP_MOD_ADD;
OClass.mod_type = “objectClass”;
OClass.mod_values = oc_values;.
char *gn_values[ ] = { “John”, NULL };
FName.mod_op = LDAP_MOD_ADD;
FName.mod_type = “givenName”;
FName.mod_values = gn_values;.
char *sn_values[ ] = { “Smith”, NULL };
LName.mod_op = LDAP_MOD_ADD;
LName.mod_type = “sn”;
LName.mod_values = sn_values;.
char *ti_values[ ] = { “Developer”, NULL };
Title.mod_op = LDAP_MOD_ADD;
Title.mod_type = “title”;
Title.mod_values = ti_values;.
char *pn_values[ ] = { “425) 999-9999”, NULL };
Phone.mod_op = LDAP_MOD_ADD;
Phone.mod_type = “telephoneNumber”;
Phone.mod_values = pn_values;.
// Build the array of attributes.
LDAPMod *NewEntry[7];
NewEntry[0] = &Name;
NewEntry[1] = &OClass
NewEntry[2] = &FName;
NewEntry[3] = &LName;
NewEntry[4] = &Title;
NewEntry[5] = &Phone;
NewEntry[6] = NULL;
// Add the entry.
ldap_add( ld, entry_dn, NewEntry);
Read/Search (Reformatted)
ULONG errorCode = LDAP_SUCCESS;
LDAPMessage* pSearchResult;
PCHAR pMyFilter = “(&(samAccountName=jsmith)(objectClass=user))”;
PCHAR pMyAttributes[6];
pMyAttributes[0] = “cn”;
pMyAttributes[1] = “givenName”;
pMyAttributes[2] = “surname”;
pMyAttributes[3] = “telephoneNumber”;
pMyAttributes[4] = “title”;
pMyAttributes[5] = NULL;
errorCode = ldap_search_s(
    pLdapConnection, // Session handle
    pMyDN, // DN to start search
    LDAP_SCOPE_SUBTREE;
    pMyFilter, // Filter
    pMyAttributes, // Retrieve list of attrs
    0, // Get both attrs and values
    &pSearchResult); // [out] Search results
// ... process the result....
```

As discussed herein, the interface 305 may use the class definitions used by the application 303 in translating commands in either direction. Accordingly, the interface 305 preferably also supports an interface to the class definitions. In an embodiment of the invention, the directory interface 305 does not translate the command fully to one that embodies the lightweight directory access protocol. Rather the interface 305 translates the command to one that is appropriate for another API such as a system directory service API 307, which in turns fulfills the command through an LDAP API 309. The system directory service API 307 and LDAP API are familiar to those of skill in the art. Thus it will be appreciated that the interface between the directory interface 305 and the repository 311 may be direct or may comprise additional APIs, and that the APIs may be changed appropriately to address different types of repositories, and that the APIs may be combined or further segmented without limitation.

Exemplary API definitions usable in the translation process include the following for read, write, and search:

```
[DirectoryClass(“user”)]
public class Person : Object
{
  [DirectoryAttribute(“givenName”)]
  public string FirstName;
  [DirectoryAttribute(“surname”)]
  public string LastName;
  [DirectoryAttribute(“telephoneNumber”)]
  pubic string TelephoneNumber;
  [DirectoryAttribute(“title”)]
  public string Title;
  [DirectoryGuid( )]
  Guid objectGuid;
  public Person Spouse;
  public PersonCollection Children;
  DateTime Birthday;
}
```

As discussed above, the directory interface 305, either alone in conjunction with other interfaces or APIs, also translates results received from the repository. Exemplary LDAP formatted results from a directory service etc. for read, write, and search commands typically have the following form and complexity:

```
ULONG errorCode = LDAP_SUCCESS;
LDAPMessage* pSearchResult;
PCHAR pMyFilter = “(&(department=101)(objectClass=user))”;
PCHAR pMyAttributes[6];
pMyAttributes[0] = “cn”;
pMyAttributes[1] = “givenName”;
pMyAttributes[2] = “surname”;
pMyAttributes[3] = “telephoneNumber”;
pMyAttributes[4] = “title”;
pMyAttributesl[5] = NULL;
errorCode = ldap_search_s(
                pLdapConnection, // Session handle
                pMyDN, // DN to start search
                LDAP_SCOPE_SUBTREE;
                pMyFilter, // Filter
                pMyAttributes, // Retrieve list of attrs
                0, // Get both attrs and values
                &pSearchResult); // [out] Search results
// Convert error code and cleanup pMsg, if necessary.
if (dwErr != LDAP_SUCCESS)
{
    hr = HRESULT_FROM_WIN32(dwErr);
    if (pMsg != NULL)
      ldap_msgfree(pMsg);
    return;
}
ULONG numberOfEntries;
    numberOfEntries = ldap_count_entries(
                        pLdapConnection, // Session handle
                        pSearchResult); // Search result
if(numberOfEntries == NULL)
{
    printf(“ldap_count_entries failed with 0x%01x \n”,errorCode);
    ldap_unbind_s(pLdapConnection);
    if(pSearchResult != NULL)
        ldap_msgfree(pSearchResult);
    return −1;
}
else
    printf(“ldap_count_entries succeeded \n”);
printf(“The number of entries is: %d \n”, numberOfEntries);
//----------------------------------------------------------
// Loop through the search entries, get, and output the
// requested list of attributes and values.
//----------------------------------------------------------
LDAPMessage* pEntry = NULL;
PCHAR pEntryDN = NULL;
ULONG iCnt = 0;
char* sMsg;
BerElement* pBer = NULL;
PCHAR pAttribute = NULL;
PCHAR* ppValue = NULL;
ULONG iValue = 0;
for( iCnt=0; iCnt < numberOfEntries; iCnt++ )
{
    // Get the first/next entry.
    if( !iCnt )
        pEntry = ldap_first_entry(pLdapConnection, pSearchResult);
    else
        pEntry = ldap_next_entry(pLdapConnection, pEntry);
    // Output a status message.
    sMsg = (!iCnt ? “ldap_first_entry” : “ldap_next_entry”);
    if( pEntry == NULL )
    {
        printf(“%s failed with 0x%01x \n”, sMsg, LdapGetLastError( ));
        ldap_unbind_s(pLdapConnection);
        ldap_msgfree(pSearchResult);
        return −1;
    }
    else
        printf(“%s succeeded\n”,sMsg);
// Output the entry number.
printf(“ENTRY NUMBER %i \n”, iCnt);
// Get the first attribute name.
pAttribute = ldap_first_attribute(
                pLdapConnection, // Session handle
                pEntry, // Current entry
                &pBer); // [out] Current BerElement
// Output the attribute names for the current object
// and output values.
while(pAttribute != NULL)
{
    // Output the attribute name.
    printf(“ ATTR: %s”,pAttribute);
    // Get the string values.
    ppValue = ldap_get_values(
                        pLdapConnection, // Session Handle
                        pEntry, // Current entry
                        pAttribute); // Current attribute
    // Print status if no values returned (NULL ptr)
    if(ppValue == NULL)
    {
        printf(“: [NO ATTRIBUTE VALUE RETURNED]”);
    }
    // Output the attribute values
    else
    {
        iValue = ldap_count_values(ppValue);
        if(!iValue)
        {
            printf(“: [BAD VALUE LIST]”);
        }
        else
        {
            // Output the first attribute value
            printf(“: %s”, *ppValue);
            // Output more values if available
            ULONG z;
            for(z=1; z<iValue; z++)
                {
                    printf(“, %s”, ppValue[z]);
                }
            }
        }
        // Free memory.
        if(ppValue != NULL)
            ldap_value_free(ppValue);
        ppValue = NULL;
        ldap_memfree(pAttribute);
        // Get next attribute name.
        pAttribute = ldap_next_attribute(
                        pLdapConnection, // Sesion Handle
                        pEntry, // Current entry
                        pBer); // Current BerElement
        printf(“\n”);
    }
    if( pBer != NULL )
        ber_free(pBer,0);
    pBer = NULL;
}
//----------------------------------------------------------
// Normal cleanup and exit.
//----------------------------------------------------------
ldap_unbind(pLdapConnection);
ldap_msgfree(pSearchResult);
ldap_value_free(ppValue);
```

In contrast, for example, the simplified results (i.e. using the appropriate class structure rather than the directory schema and programming model) for the same commands typically may have the following form:

```
Resultset
// Find all persons in the department 101
Person person = new Person( );
person.DepartmentNumber = “101”; //
foreach(Person p in DirectoryContext.FindAll(person))
{
    Console.WriteLine( c.FirstName);
    Console.WriteLine( c.LastName);
}
```

The ability of the interface 305 to translate a command that uses a class structure of the calling application to one that is repository specific, such as by being LDAP-compliant, and vice versa, is accomplished in an embodiment of the invention by reading the class structure of the relevant object class to access the class properties and associated metadata that maps the class structure used by the application to the schema of the repository. Within the .NET™ Common Language Runtime produced by Microsoft® Corporation of Redmond, Wash., the technique of CLR reflection may be used to read the properties and metadata.

A class according to the .NET Common Language Runtime (CLR) has one or more properties associated with it. Thus, for example, a CLR class called “user” may have properties of “first name,” “last name,” “date of birth,” and so on. A schema for an LDAP directory, such as Active Directory® and others, has an organizational structure whereby information is sorted into classes or categories, and attributes thereof. Thus, for example, an LDAP directory may specify that information of a class “user” has attributes of “surname,” “given name,” etc.

In an embodiment of the invention, classes and attributes of the schema of the repository 311 are mapped to respective parallel classes and properties of the class structure used by the directory application 303. The resultant mapping is used by the directory interface, such as interface 305 of FIG. 3, to access the directory 311 given a high-level command from the application 303. The manner in which such mappings are selected and the mechanism for storing the mappings are not critical, but exemplary mechanisms are described hereinafter.

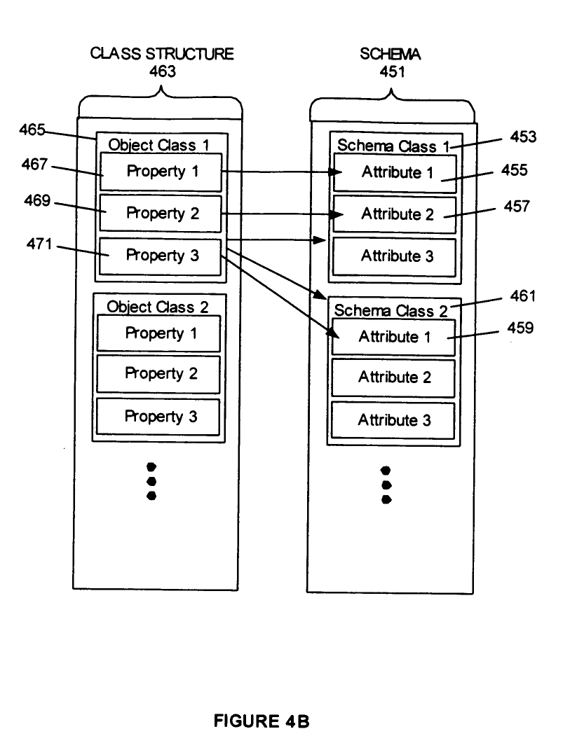

Referring now to FIG. 4A, a mapping between an object class structure and a directory schema is shown. In particular, a directory of interest uses a schema 401 having at least the class 403 of “user” having at least the attributes of “surname” (405), “given name” (407) and “date of birth” (409). It will be appreciated that the schema 401 typically will have more than one class and typically will have at least one other class 411, and that the principles described herein apply to each such class. The application used to access the directory employs a class structure 413 having at least the class 415 of “Person” having at least the properties of “last name” (417), “first name” (419) and “date of birth” (421). As with the schema 401, it will be appreciated that the class structure 413 will typically define a number of other classes 423 as well, and that the principles described herein apply to each such class and its properties. Each class of the class structure, such as the “person” class 415, is mapped to a class of the directory schema 401, such as the user class 403. Moreover, each property of a mapped class 415 is mapped to a particular attribute of the corresponding schema class 403.

It is not required that every class of the class structure 413 be mapped to a class of the directory schema 401, nor that every property of a mapped class be mapped to some attribute of the corresponding schema class. Moreover, a particular mapped class may be mapped to a plurality of schema classes within an embodiment of the invention. An example of such is illustrated in FIG. 4B. In particular, property 1 (467), property 2 (469), and property 3 (471) of class 1 (465) of the class structure 463 are mapped respectively to attribute 1 (455) and attribute 2 (457) of class 1 (453) of the directory schema 451, and attribute 1 (459) of class 2 (461) of the directory schema 451.

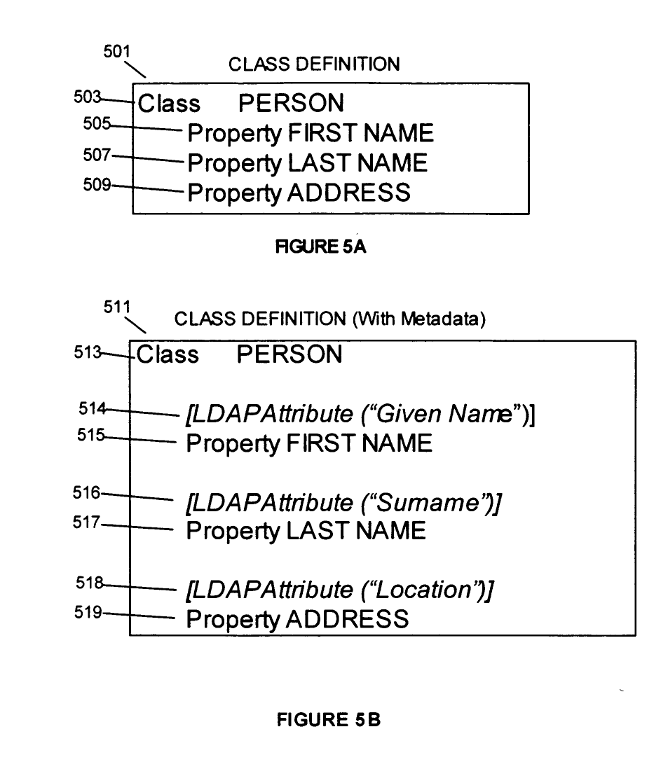

The mapping of class structure classes to directory schema classes, and of class properties to schema class attributes, may be recorded or embodied in any appropriate form. For example, in an embodiment of the invention, the mappings are embodied in a listing that is accessible to the directory interface. However, in another embodiment of the invention, the mappings are embodied via metadata tagging within the class definition itself. An exemplary simplified class definition and the tagging of the class definition are illustrated in FIGS. 5A and 5B respectively. In particular, in FIG. 5A, the class definition 501 appears with no metadata tagging.

The class is defined in FIG. 5A as having a name 503 (PERSON), and as having three properties, “First Name” 505, “Last Name” 507, and “Address” 509. However, in FIG. 5B, the class definition 511 appears with metadata inserted. In particular, the class PERSON has three sections of metadata 514, 516, 518 associating the three class properties, “First Name” 515, “Last Name” 517, and “Address” 519 with the LDAP attributes “Given Name,” Surname,” and “Location” respectively. Although each displayed property of the class PERSON is associated with a metadata tag in FIG. 5B, it should be appreciated that it is not necessary that each property be tagged. Furthermore, it should be appreciated that the directory schema classes that may be associated with the listed schema attributes need not be the same from one attribute to the next.

Those of skill in the art will be familiar with the use of metadata within class definitions, for example to create self-describing objects. For example, in the .NET™ Common Language Runtime platform produced by Microsoft® Corporation, the tagging of various aspects of a class via metadata is supported. In an embodiment of the invention, the metadata is inserted manually in the class definition by a developer. However, this requires a technical ability that many administrators and other common users may not possess, and thus the flexibility of the system is diminished somewhat by the inability of ordinary users to easily change or supplement the associations without technical assistance.

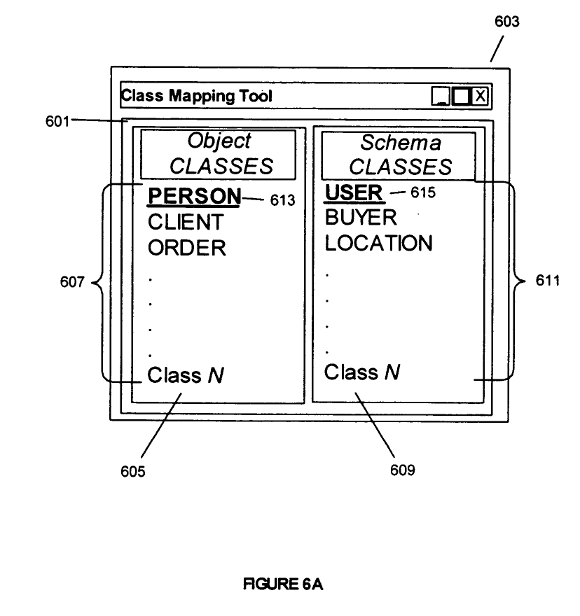

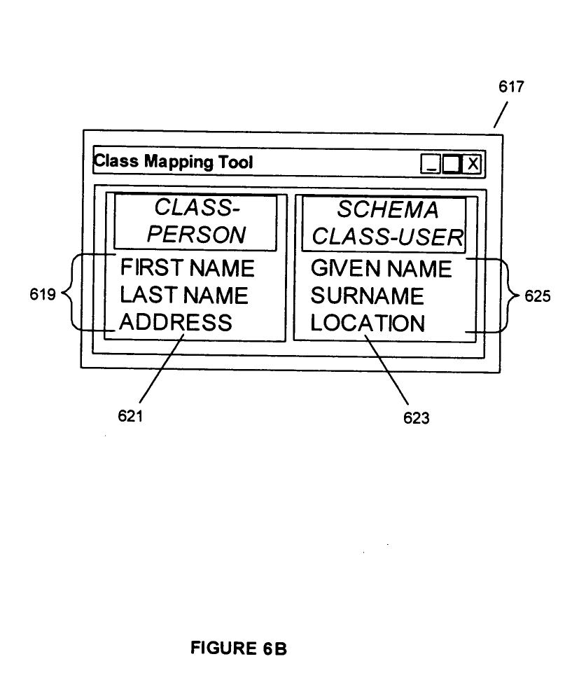

Accordingly, in an embodiment of the invention, a simplified mapping tool is provided to allow a user to create the object class/schema class and property/attribute associations that they wish to have. Users of the mapping tool would typically include administrators, such as web site administrators, managers and others associated with an enterprise, as opposed to customers and casual users. Two user interfaces for the mapping tool are illustrated in FIGS. 6A and 6B corresponding to sequential stages of a mapping operation. As shown in FIG. 6A, the simplified mapping tool presents the user with a graphical means for choosing mappings. In particular, the user interface 601 presented within window 603 displays a class field 605 listing available classes 607. Similarly, a schema class field 609 displays a listing of available schema classes 611. It can be seen in the example of FIG. 6A that the user has selected a class PERSON 613 from the listing of available classes and a schema class USER 615 from the listing of available schema classes 61 1.

In order to initiate a mapping between a selected object class and a selected schema class any number of actuation conventions may be used. In an embodiment of the invention, simply selecting a schema class after having selected an object class initiates mapping. In alternative embodiments of the invention, initiation of mapping may be caused by any of a number of actions including double-clicking of the second selection and selection of a menu item or icon after selection of both object class and schema class.

Whatever the mechanism chosen for initiating a mapping, once a mapping is initiated the user is shown another set of options as shown in window 617 of FIG. 6B in order to facilitate mapping of individual class properties with corresponding individual directory schema attributes. In particular, the window 617 contains a property field 621 having therein a listing 619 of properties of the selected class (PERSON) as well as an attribute field 623 having therein a listing 625 of attributes of the selected directory schema class (USER). At this point, the user simply selects a property from the listing 619 within the property field 621 and an attribute from the listing 625 within the attribute field 623. As with the interface of FIG. 6A, the manner in which the selection is entered is not critical, but exemplary methods include double-clicking, icon or menu item selection, the act of the second selection itself, and so on.

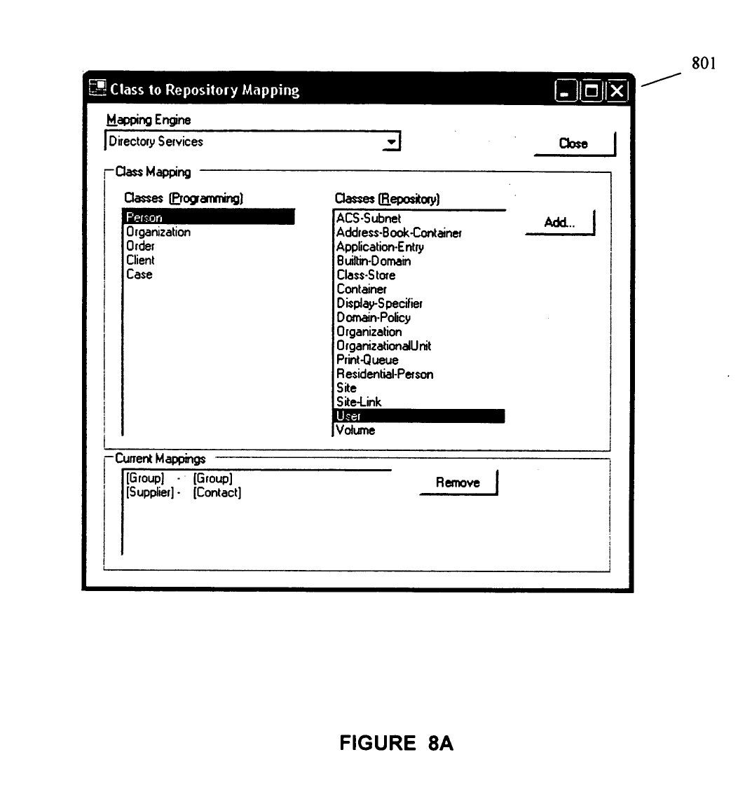

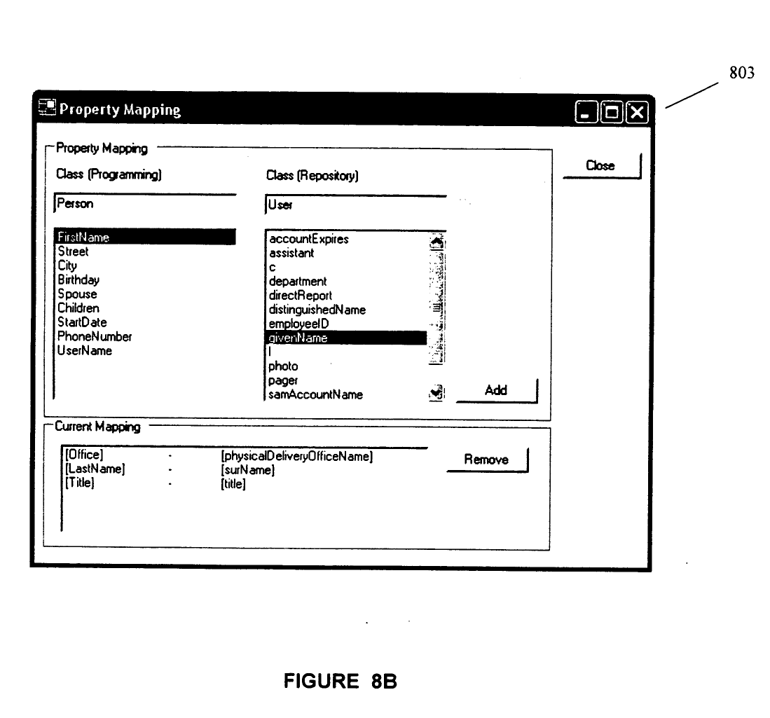

The screen shots of FIGS. 8A and 8B illustrate alternative user interface elements usable to facilitate the mapping described above. In particular, FIG. 8A shows a screen shot 801 of a user interface for mapping object classes to schema classes according to an alternative embodiment of the invention. FIG. 8B shows a screen shot 803 of a user interface for mapping object class properties to schema class attributes according to an alternative embodiment of the invention. As described above with respect to FIGS. 6A and 6B, the user interface for mapping object class properties to schema class attributes preferably becomes visible and/or usable after a selection in the user interface for mapping object classes to schema classes has been made.

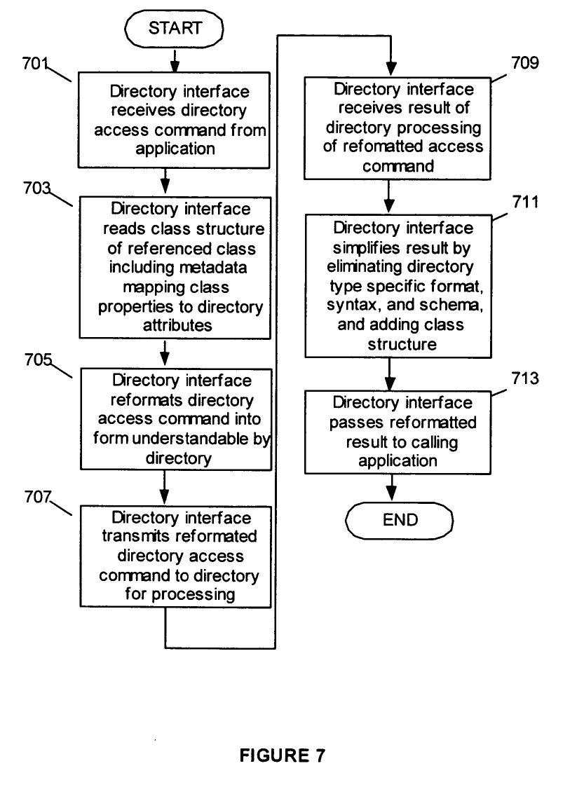

Once the user has finalized a mapping as described above, the mapping tool accesses the relevant class definition and supplements the appropriate property with metadata identifying the directory schema attribute to which the property is mapped. At this point, the annotated class definition is available to the directory interface, illustrated by element 305 of FIG. 3, discussed above. The operation of the interface 305 during repository access will now be described in greater detail by reference to the flow chart of FIG. 7.

Initially, at step 701, the interface 305 receives a directory access command from an application such as directory application 303 of FIG. 3. The directory application may be for example an order processing application that seeks to access the directory 311 in order to read, write, or alter customer information or order information or to perform a search or query. The directory access command will typically be one of a read, write, and search command, although other command types are contemplated within embodiments of the invention as well. As discussed above, the directory access command identifies the desired information in terms of properties of the relevant class or classes rather than as attributes defined by the directory schema. Moreover, the syntax and format of the directory access command are simplified and non-repository specific, identifying simply the class and property to retrieve and the repository. Thus for example, in an embodiment of the invention the following access command could be used to initiate a read of the address of a customer “John Smith” stored in an LDAP directory known as “directory 1”: Read [PERSON(John Smith)(Address)]from[directory 1] using the class structure shown in FIG. 6A. In an embodiment of the invention the access command may identify the directory type, such as “LDAP,” but such is not required.

Once the directory interface 305 has received a directory access command, it reads the class structure of the class referenced in the access command in step 703 and reads the metadata defining the mapping of the relevant class (PERSON) to one or more schema classes and of the properties of the class to corresponding attributes of the relevant class or classes. After reading the class information and mapping, the directory interface reformats the directory access request in step 705 to account for the specific directory type being accessed. In the foregoing example of an LDAP directory, the directory interface formats the access command as an LDAP-compliant command. Note that in an embodiment of the invention, the directory interface uses one or more existing APIs to finish processing of the command into a form understandable by the directory 311. In an alternative embodiment of the invention, the directory interface 305 reformats the access command without assistance from other APIs into a form understandable by the directory 311.

At step 707, the directory interface transmits the reformatted access command to the directory 311 for processing. In an embodiment of the invention wherein the directory interface uses additional APIs to complete a portion of the reformatting, the transmission of the reformatted access command to the directory may be indirectly accomplished such as via one of the other APIs upon completion of that API's portion of the formatting task. After the directory 311 has appropriately processed the reformatted directory access command, it returns the results for receipt by the directory interface in step 709. The returned results may be received indirectly via one or more other APIs in embodiments of the invention.

Once the directory interface has received the result of the directory access command that it initially sent, it reformats the result in step 711. In particular, the interface simplifies the result into a reformatted result that eliminates any directory type specific format, syntax, and schema (schema classes and attributes) and that presents the result in terms of the relevant class used by the application 303 rather than the directory attributes used by the directory 311 to obtain the result. After completion of step 711, the reformatted result is passed to the calling application or user at step 713 and the process terminates.

It will be appreciated that the interface 305 has allowed the application 303 to access the directory 311 without using the syntax and programming model required by the directory 311 either in making a request for access or in receiving the results of such a request. Moreover, the application 303 was able to employ an understood class structure rather than using the schema and attributes required by the directory 311, with the access command and results being translated from or to that structure respectively via a mapping between class properties and directory schema attributes.

It will be appreciated that an improved system and method for directory access have been described. In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that some elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

We claim:

1. A method providing access to a data repository from an application, wherein data resident in the repository is organized via a schema defining at least one schema class having therein at least one attribute, the method comprising:
receiving from the application an access command, wherein the access command identifies a particular class and a particular property of the class, and wherein the access command further omits an identification of a particular schema class or a particular attribute of the schema;
translating the access command to a translated access command, wherein the translated access command identifies a particular schema class and a particular attribute of the schema, and wherein the translated access command further omits an identification of the particular class and the particular property of the class; and
transmitting the translated access command to the repository to obtain access to the repository.

2. The method according to claim 1, wherein the step of translating the access command to a translated access command comprises:
reading a mapping that identifies the particular property of the class and links the particular property of the class to the particular attribute of the schema; and
modifying the access command by removing a reference to the particular property of the class and by adding to the access command a reference to the particular attribute of the schema.

3. The method according to claim 2, wherein the step of translating the access command to a translated access command further comprises altering the format of the command such that the format of the translated access command is a format that the repository is capable of processing to grant access to the repository.

4. The method according to claim 3, wherein the step of translating the access command to a translated access command further comprises employing an application programming interface to process an intermediate command derived from the access command.

5. The method according to claim 2, wherein the particular class is defined by a class definition having therein a definition of the particular property, and at least one metadata tag associated with the definition of the particular property, and wherein reading the mapping that identifies the particular property of the class and links the particular property of the class to the particular attribute of the schema comprises reading the definition of the particular property and the associated metadata tag.

6. The method of claim 1, wherein the repository is an LDAP-compliant directory service, and wherein the schema is in accordance with the LDAP protocol.

7. The method of claim 1, wherein the repository is an LDAP-non-compliant repository, and wherein the schema is implicit.

8. The method according to claim 7, further comprising extracting the implicit schema and recording it as an express schema.

9. The method according to claim 1 further comprising:
receiving a response from the repository pursuant to transmitting the translated access command to the repository, wherein the received response identifies the particular schema class and particular attribute of the schema, and omits an identification of the particular class and the particular property of the class;
translating the received response to a translated response, wherein the translated response identifies the particular class and particular property of the class, and omits an identification of the particular schema class and the particular attribute of the schema; and
fulfilling the access command received from the application by transmitting the translated response to the application.

10. A computer-readable medium having stored thereon computer-executable instructions for performing the method according to claim 1.

11. A computer-readable medium having stored thereon computer-executable instructions for performing the method according to claim 2.

12. A computer-readable medium having stored thereon computer-executable instructions for performing the method according to claim 5.

13. The method according to claim 1, wherein transmitting the translated access command to the repository to obtain access to the repository comprises transmitting the translated access command to an intermediary filter component that transmits a corresponding filtered translated access command to the repository.

14. The method according to claim 13, wherein the intermediary filter component comprises at least one application programming interface.

15. The method according to claim 1, wherein the access command is selected from the group consisting of a read command, a write command, and a search command.

16. A directory interface for facilitating simplified access by an application to a repository wherein data is organized in accordance with a schema having at least one attribute, the directory interface comprising:
an application interface for receiving from the application an access command that omits an identification of the at least one attribute and for transmitting to the application a translated repository response that also omits an identification of the at least one attribute; and
a repository interface for transmitting a translated access command to the repository, wherein the translated access command is derived from the access command and includes an identification of the at least one attribute, and for receiving a repository response from which the translated repository response is derived, wherein the repository response also includes an identification of the at least one attribute.

17. The directory interface according to claim 16, wherein the repository interface comprises an application programming interface.

18. The directory interface according to claim 17, wherein the repository is LDAP-compliant and wherein the application programming interface of the repository interface comprises an LDAP API.

19. A computer-readable medium having thereon a computer-readable data structure defining a class definition, wherein the class definition comprises:
a definition of a class including a definition of at least one property of the class; and
metadata associated with the definition of at least one property of the class, wherein the metadata identifies an attribute of a directory schema.

20. The computer-readable medium according to claim 19, wherein the definition of the class comprises a plurality of definitions of a respective plurality of properties of the class, and wherein the metadata comprises metadata associated with each of the plurality of definitions.

21. The computer-readable medium according to claim 20, wherein metadata associated with a first of the plurality of definitions identifies an attribute of a first schema class within the directory schema and metadata associated with a second of the plurality of definitions identifies an attribute of a second schema class within the directory schema.

22. A mapping tool embodied on a computer-readable medium for associating a property of a class with an attribute of a schema class of a repository schema, the mapping tool comprising:
computer-executable instructions for presenting a first graphical user interface for user-selection of a selected class to be mapped to a selected schema class and for receiving a user selection of the selected class and the selected schema class;
computer-executable instructions for presenting a second graphical user interface for user-selection of a selected property of the selected class and a selected attribute of the selected schema class and for receiving a user selection of the selected property and the selected attribute; and
computer-executable instructions for annotating a definition of the selected class with metadata associating the selected property with the selected attribute in response to receiving a user selection of the selected property and the selected attribute.
